(19) United States
(12) Patent Application Publication
(10) Pub. No.: US 2003/0214117 A1
(43) Pub. Date: Nov. 20, 2003

(54) Collapsible trailer

(76) Inventors: Karl M. Steins, San Diego, CA (US); Adrian Corbett, San Diego, CA (US)

Correspondence Address: Karl M. Steins, Steins & Associates, Suite 120, 2333 Camino del Rio South, San Diego, CA, 92108, US

(21) Appl. No.: 10/150,601

(22) Filed: May 17, 2002

(51) Int. Cl. B62D 63/06

(52) U.S. Cl. 280/656

(57) ABSTRACT

A Collapsible Trailer is disclosed. Also disclosed is a trailer that is lightweight, but durable, and includes a set of detachable deck segments that can be assembled into a deck. The trailer further includes a suspension assembly that attaches to the deck once the deck is assembled. Still further, the trailer includes at least one longitudinal member for providing a frame to partially support the assembled deck. There are versions of the trailer that are held together by cable systems, as well as versions that include a metal frame. If the trailer has a frame, there are versions having an external frame, as well as versions having a frame that is internal to the deck segments. In any case, the deck segments, when disassembled, stackable into a condensed deck stack.

### BACKGROUND OF THE INVENTION

1. Field of the Invention

This invention relates generally to cargo hauling and, more specifically, to a Collapsible Trailer.

2. Description of Related Art

Cars and trucks have become a mainstay of the modern active lifestyle. Unfortunately, due to garaging space limitations, each family is only realistically capable of having two vehicles in any single household. As a result of this, each household must make a choice as to what species of vehicle to obtain, depending upon their particular needs and circumstances. In recent years, that choice has been the Sport Utility Vehicle or SUV's. While the SUV certainly has attempted to “bridge the gap” between the utility vehicle and the passenger vehicle, it has almost gone too far. Certainly, all SUV's have the capability and design to haul a substantial amount of cargo; the problem is that they are many times too nice for this application. As a result, the user must rent or borrow.

### SUMMARY OF THE INVENTION

In light of the aforementioned problems associated with the prior devices, it is an object of the present invention to provide a Collapsible Trailer. The trailer should be lightweight, but durable, and include a set of detachable deck segments that can be assembled into a deck. The trailer should further include a suspension assembly that attaches to the deck once the deck is assembled. Still further, the trailer should include at least one longitudinal member for providing a frame to partially support the assembled deck. There should be versions of the trailer that are held together by cable systems, as well as versions that include a metal frame. If the trailer has a frame, there should be versions having an external frame, as well as versions having a frame that is internal to the deck segments. In any case, the deck segments, when disassembled, should stack into a condensed deck stack.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a side view of a first embodiment of the collapsible trailer of the present invention;

FIG. 2 is a top view of the trailer of FIG. 1;

FIG. 3 is an exploded side view of a second embodiment of the collapsible trailer of the present invention;

FIG. 4 is a partial top view of the trailer of FIG. 2;

FIG. 5 are side views of the deck of the trailers of FIGS. 1-4;

FIG. 6 is a top view of a third embodiment of the collapsible trailer of the present invention;

FIG. 7 is a side view of the trailer of FIG. 6;

FIG. 8 is an exploded side view of the trailer of FIGS. 6 and 7;

FIGS. 9A and 9B are side views of the deck of the trailer of FIGS. 6-8;

FIG. 10 is a top view of the frame of the trailer of FIGS. 6-9;

FIG. 11 is a top view of the collapsed frame of the trailer of FIGS. 6-10;

FIGS. 12A-12C are top, top and side views, respectively, of a fourth embodiment of the collapsible trailer of the present invention;

FIGS. 13A-13C are top, top and side views, respectively, of a fifth embodiment of the collapsible trailer of the present invention;

FIGS. 14A and 14B are embodiments of the tail and head deck segment designs for the trailers of FIGS. 12 and 13;

FIG. 15 is a partial cutaway perspective view of a third alternate suspension assembly of the trailer of the present invention;

FIGS. 16A and 16B are partial cutaway perspective views of a third and fifth alternate suspension assembly, respectively, of the trailer of the present invention; and

FIG. 17 is an exploded top view of a sixth embodiment of the collapsible trailer of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Collapsible Trailer.

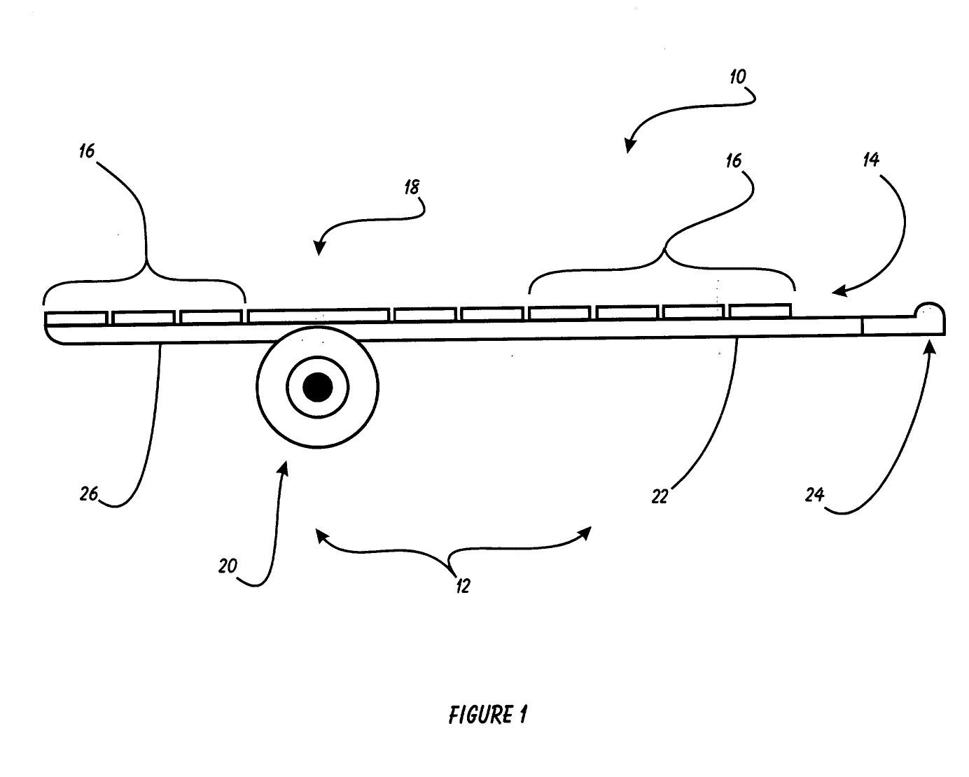

The present invention can best be understood by initial consideration of FIG. 1. FIG. 1 is a side view of a first embodiment of the collapsible trailer of the present invention. This embodiment of the trailer 10 comprises a collapsing frame 12 to which is attached a collapsible deck 14 for hauling cargo thereon. The preferred deck 14 is constructed from a plurality of segments 16 held together by a flexible retention structure, such as cables, as will be described below in connection with other figures. In this embodiment, the deck 14 further comprises a suspension assembly 18 to which attaches the front series of segments 16 and rear series of segments 16. The suspension assembly (in this embodiment) further includes a wheel assembly 20, which is described more fully below.

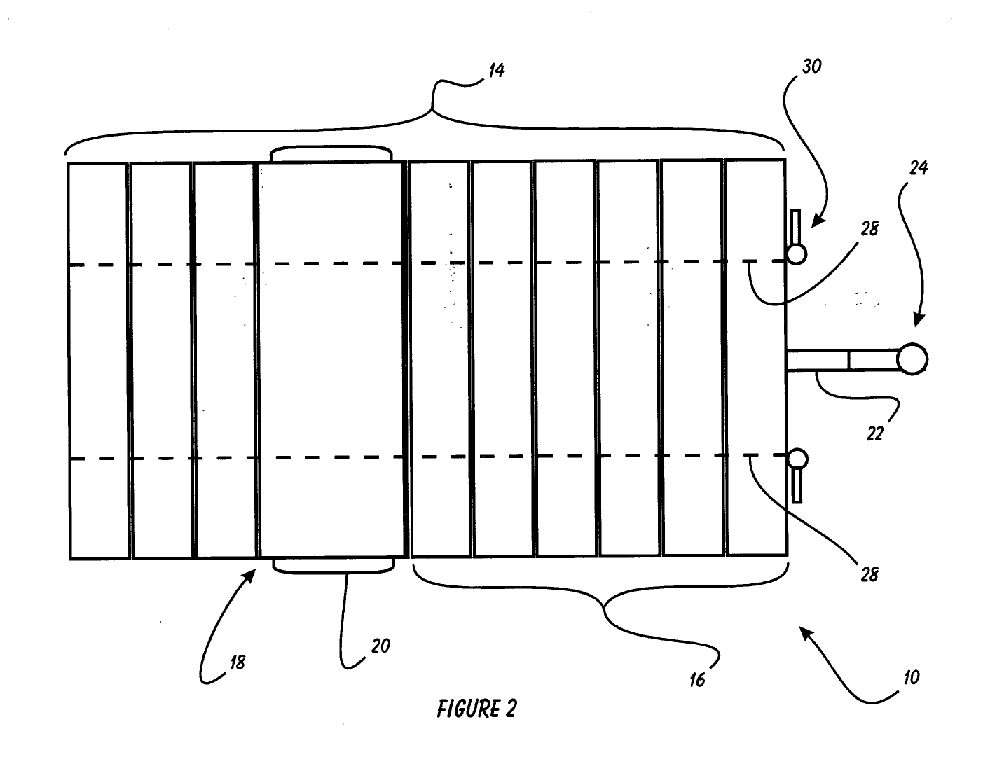

In support of the deck 14 is the collapsible frame 12. The frame 12 (in this embodiment) comprises at least one first longitudinal strut 22 extending forwardly from the suspension assembly 18 and terminating in the hitch socket 24 for engaging a conventional towing ball. Extending rearwardly from the suspension assembly is one or more second longitudinal struts 26. The segments 16 and frame 14 are preferably constructed from a lightweight, strong material, such as aluminum. Now turning to FIG. 2, we can examine further detail regarding this embodiment of the collapsible trailer 10.

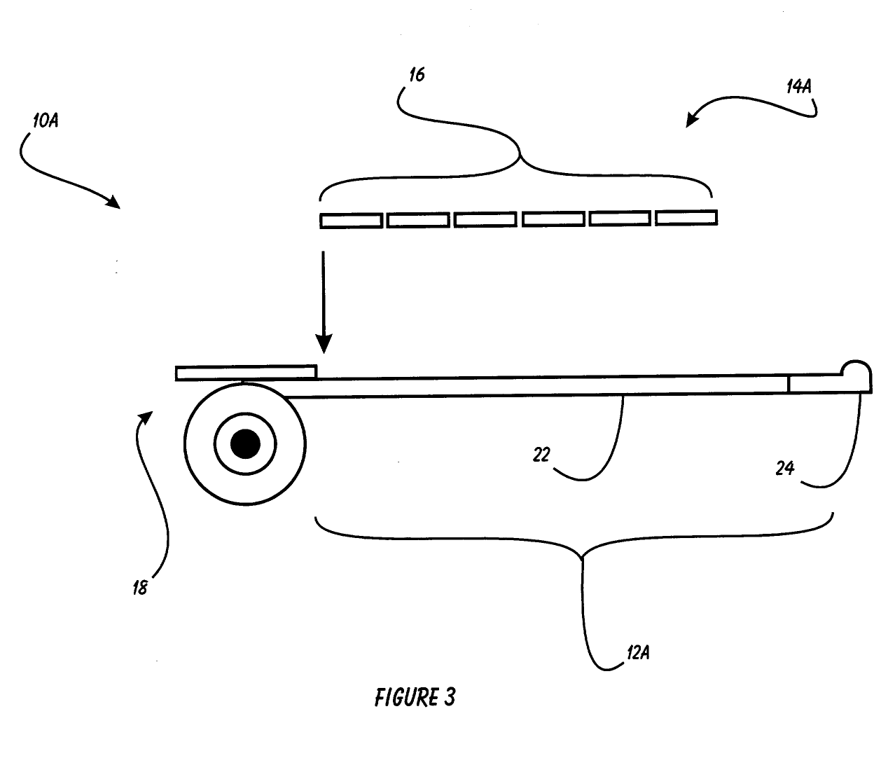

FIG. 2 is a top view of the trailer embodiment of FIG. 1. As can be seen here, the segments 16 are held together by one or more tensioning cables 28 extending along the length of the trailer 10. In this embodiment, the tensioning cables 28 are tightened and loosened by tensioning means 30. The tensioning means 30 are from a wide variety of conventional cable tensioners, such as “come-alongs” (ratcheting cable tensioners) or “lift-overs,” which are adjustable tensioners that engage to tighten the cables by simply flipping the handle of the “lift-over” across to the engaged position. When tightened, the tensioning cables 28 will hold the segments 16 together in a single sturdy structural deck 14. If we now turn to FIG. 3, we can examiner another preferred embodiment of the trailer of the present invention.

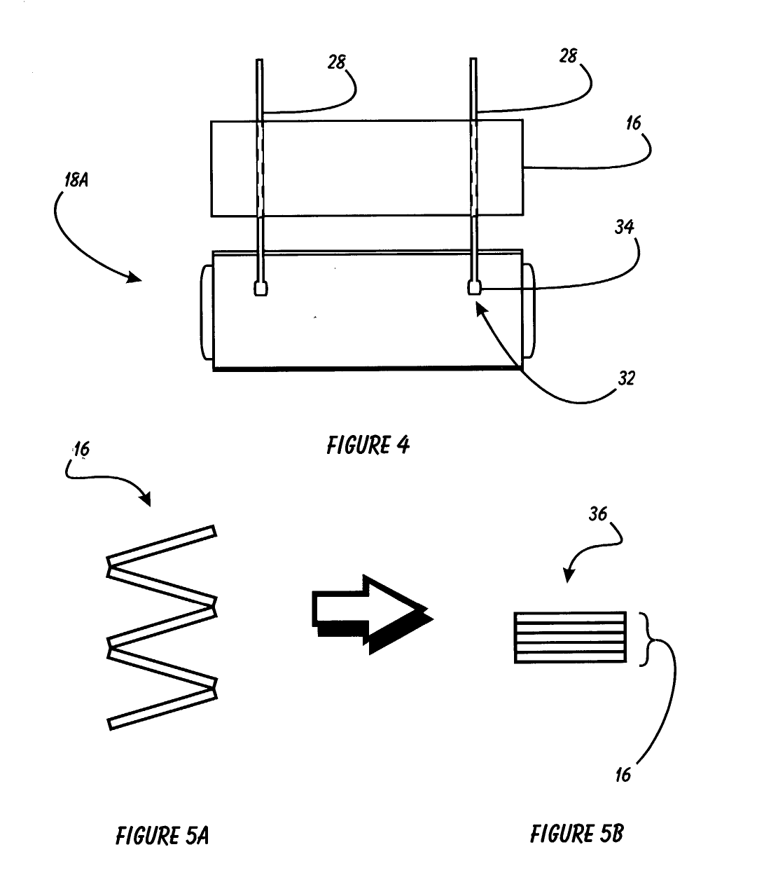

FIG. 3 is an alternate embodiment 10A of the trailer of the present invention. In this embodiment, the trailer 10A is configured in two separable modules, namely the deck 14A and the frame 12A. The deck 14A in this embodiment extends only in the frontward direction from the suspension assembly 18. Similarly, the frame 14A only comprises one or more first longitudinal struts 22, and no second longitudinal struts (see FIGS. 1 and 2). If we now turn to FIG. 4, we can examine how the deck 14A attaches to the suspension assembly 18 in this embodiment of the trailer 10A.

FIG. 4 is a partial cutaway top view of the trailer 10A of FIG. 3. As can be seen in this embodiment, the top surface of the suspension assembly 18 is designe with one or more sockets 32 formed therein. Each socket 32 is configured to releasably accept lugs 34 formed at the end of each of the tensioning cables 28. In this manner, the trailer 10A can be disassembled very simply by de-tensioning the cables 28 (and thereby releasing the lugs 34 from the sockets 32), after which the deck module can be detached from the frame module.

FIGS. 5A and 5B depict how the detached deck can be collapsed. As can be seen in FIG. 5A, the segments 16, once de-tensioned, can be easily folded “accordion” style into the deck stack 36 depicted in FIG. 5B. So long as the deck is made from an even-numbered number of segments' 16, the dirty (bottom) side of the segments 16 can be folded to face each other, such that the cleaner outer (or deck-top) surface of the segments 16 is on the exterior of the deck stack 36.

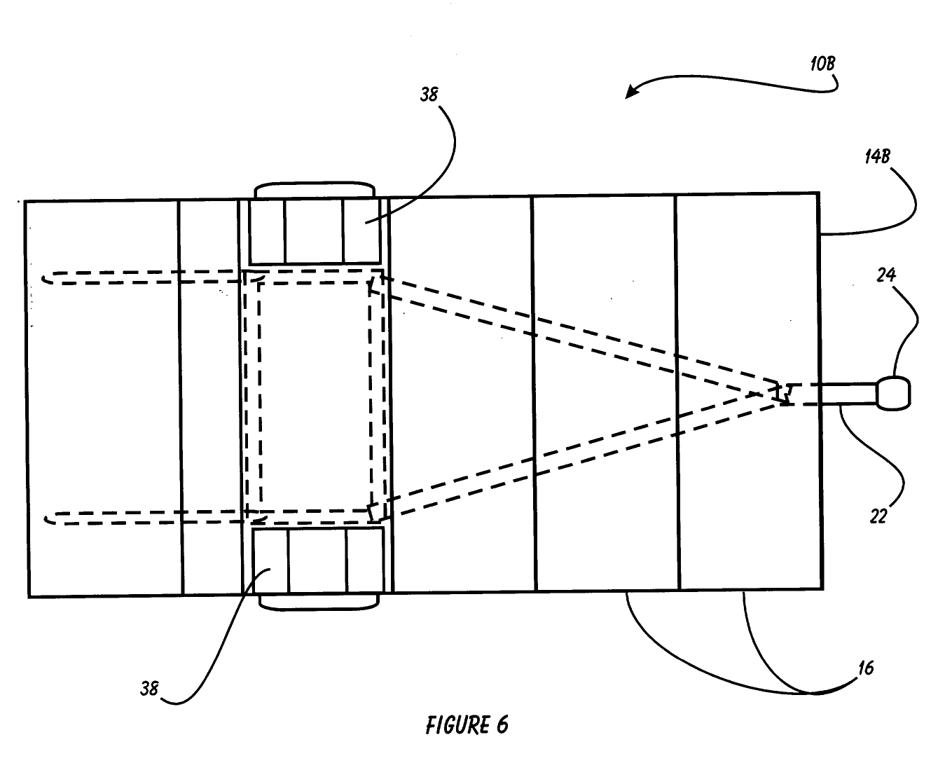

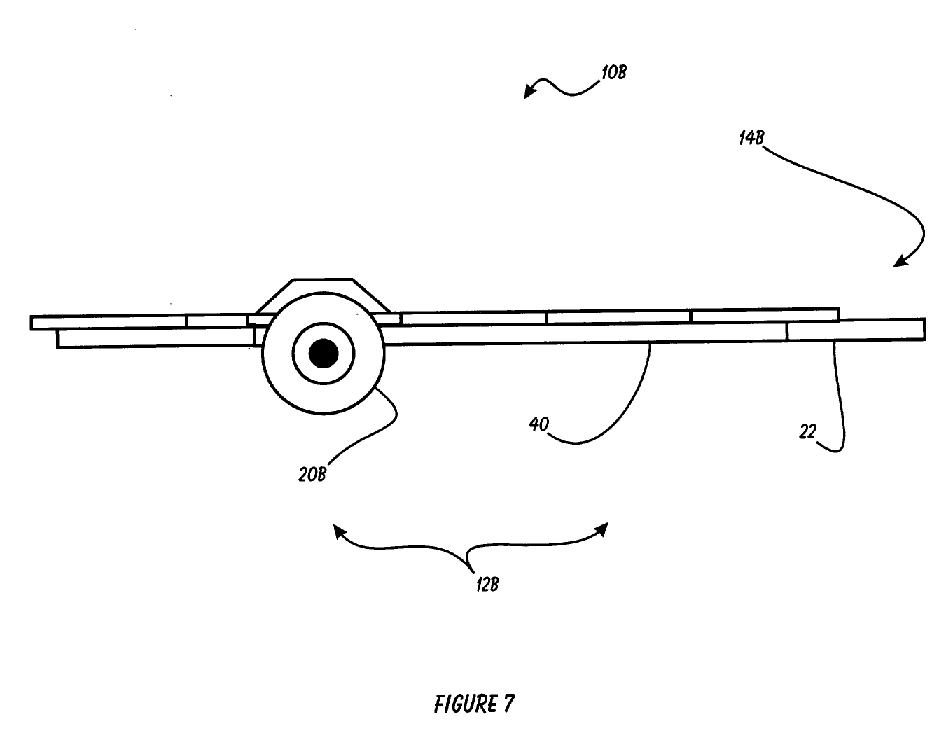

Now turning to FIG. 6, we can examine this second alternate trailer 10B design. Depicted in this top view, we can see that the segments 16 are aligned to form a solid deck 14B further defined by fenders 38. The deck 14B is attached to the frame, which comprises (in part) a first longitudinal strut 22 and terminates at its leading edge in a hitch socket 24 for detachable attachment to a conventional trailer hitch. FIG. 7 provides another view of this embodiment of the trailer 10B of the present invention.

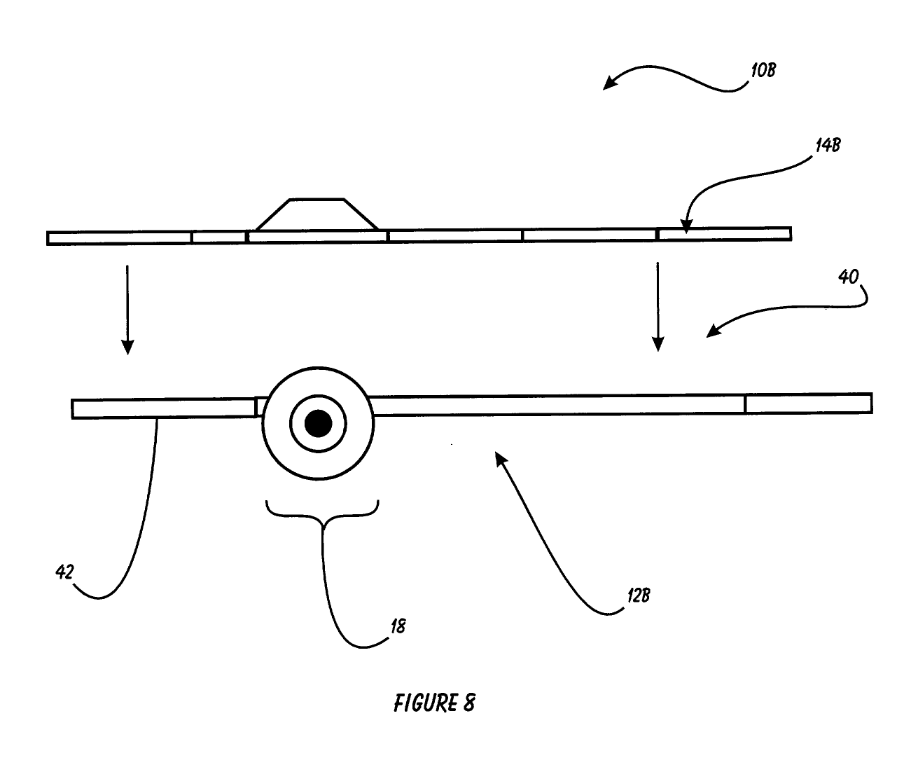

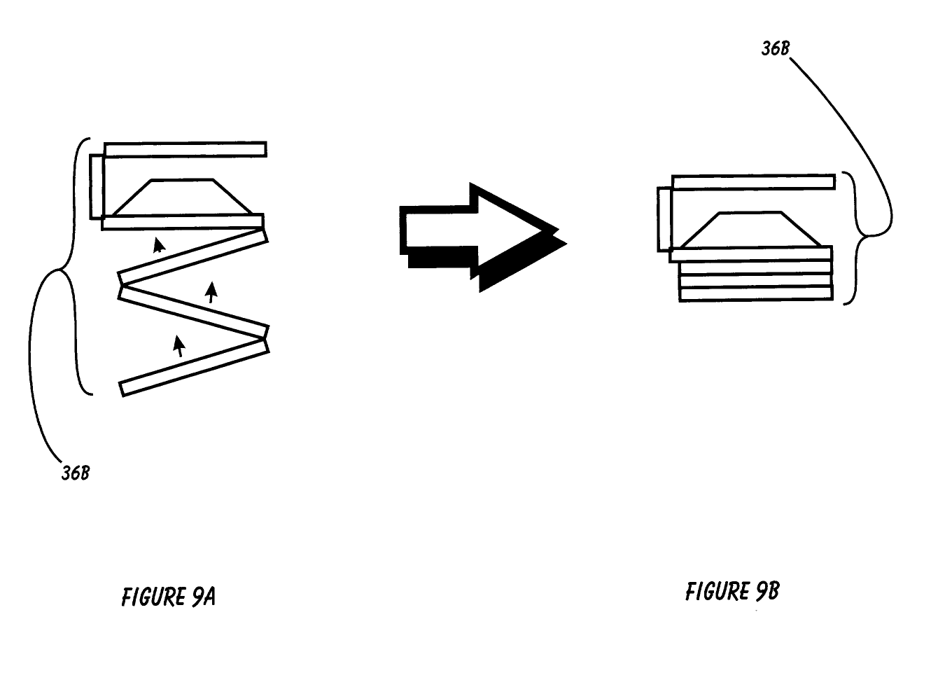

As shown in FIG. 7, we can see that the first and second intermediate struts 40 extend backwardly from the first longitudinal strut 22. The suspension assembly (to which the wheel assemblies 20B attach) attaches to the intermediate struts 40, and the tail struts 42 then extend from the suspension assembly. All of these components may be considered to make up the frame 12B of the trailer 10B. It should be understood that in some other embodiments, the trail struts and intermediate struts may be combined into single continuous members. An exploded side view of this embodiment of the trailer 10B is provided in FIG. 8. As shown, the deck 14B attaches to the upper surface of the frame 12B. Furthermore, FIGS. 9A and 9B depict how the deck 14B can be folded up to form a deck stack 36B. When folded, the deck stack 36B is an extremely compact package that is very easily handled and stored.

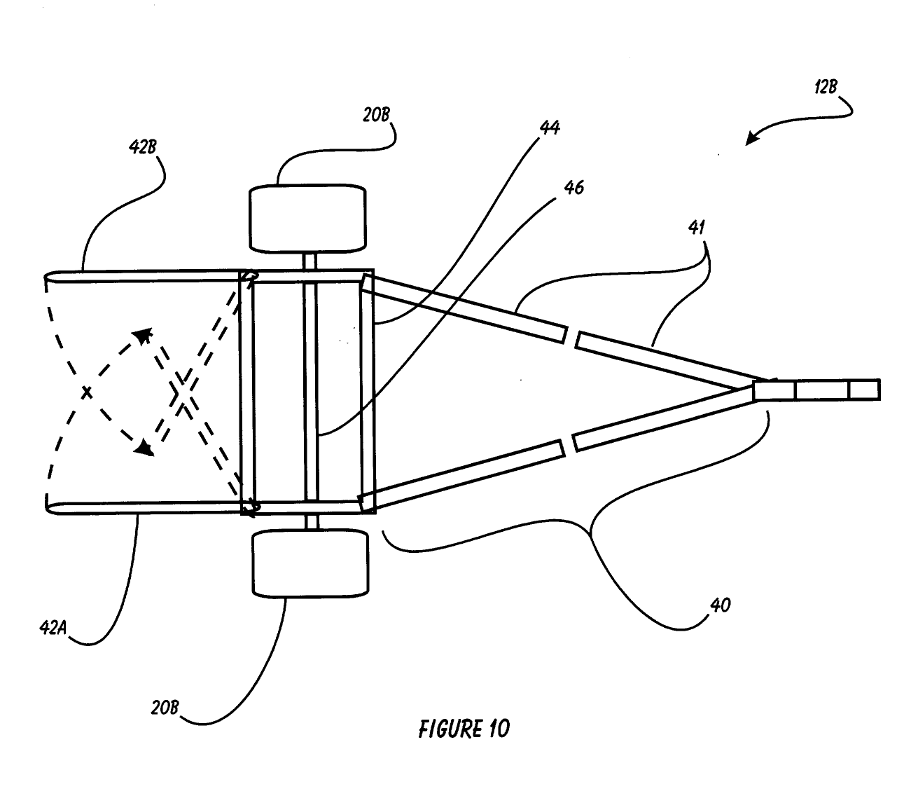

If we now turn to FIG. 10, we can examine certain specifics regarding the frame 12B of this second alternate design. FIG. 10 is a top view of the second alternate frame 12B, wherein we can see that the intermediate struts 40 are actually made up of separate strut elements 41; in this fashion, the intermediate struts 40 can be broken down into smaller, more manageable pieces.

Also shown in FIG. 10 is detail regarding the tail struts 42. In this embodiment, the first and second tail struts 42A and 42B, respectively, are hingably attached to the suspension frame 44, such that they might be collapsible against the frame 44 when the trailer 10B is being stored. Further displayed here is a conventional axle 46 connecting the two wheel assemblies 20B to one another. Although not shown, the axle 46 attaches to the suspension frame 44 via some sort of suspension, such as conventional leaf springs. In FIG. 11, which is a top view of the frame 12B completely collapsed, it can be seen that all strut elements 41 can be fit within the confines of the suspension frame 44 to form a very compact package.

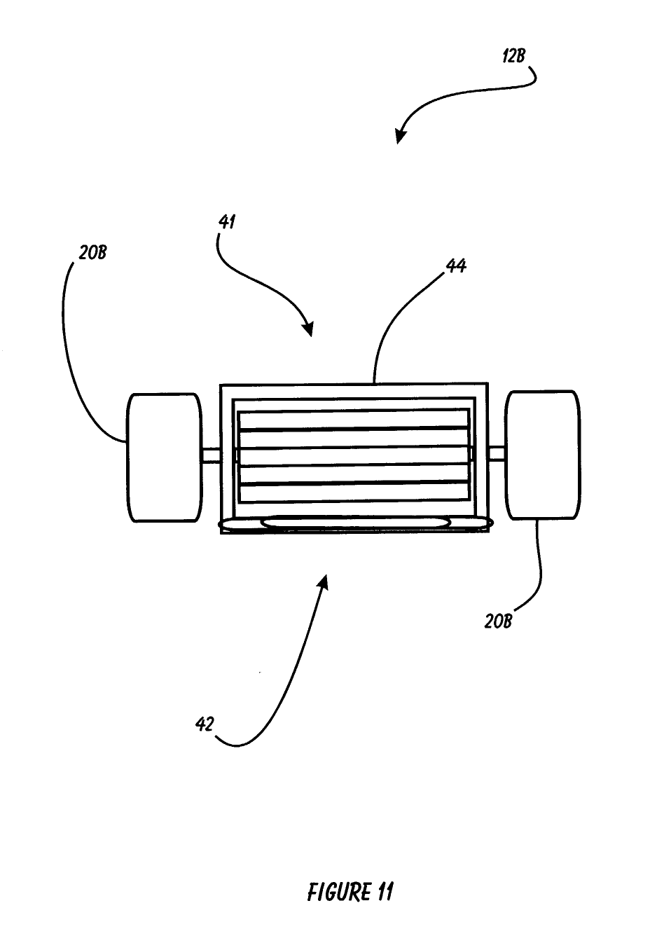

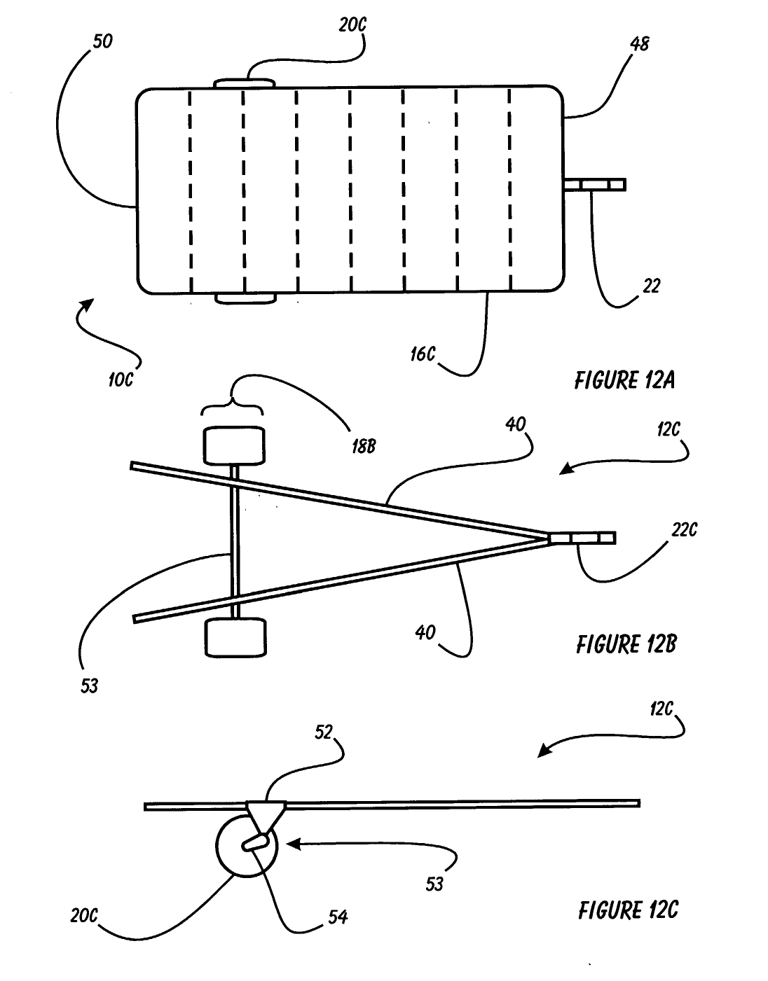

Now turning to FIGS. 12A-12C, we can examine a third embodiment of the trailer 10C of the present invention. In this example, the deck assembly 16C is mounted in a plane above the wheel assemblies 20C, such that fenders are no longer necessary. As shown in FIG. 12A, the deck assembly 16C is formed from a plurality of deck segments (see above) that terminate in a head deck segment 48 and a tail deck segment 50. The particular details of these two end segments will be discussed below in other Figures. In FIG. 12B, we see that the third alternate embodiment of the frame 12C comprises a triangle formed from the first and second intermediate struts 40 intersecting at the first longitudinal strut 22C and terminating in the hitch socket 24C. The intermediate struts 40 attach to the third alternate embodiment of the suspension assembly 18C, as depicted more fully in the side view presented in FIG. 12C.

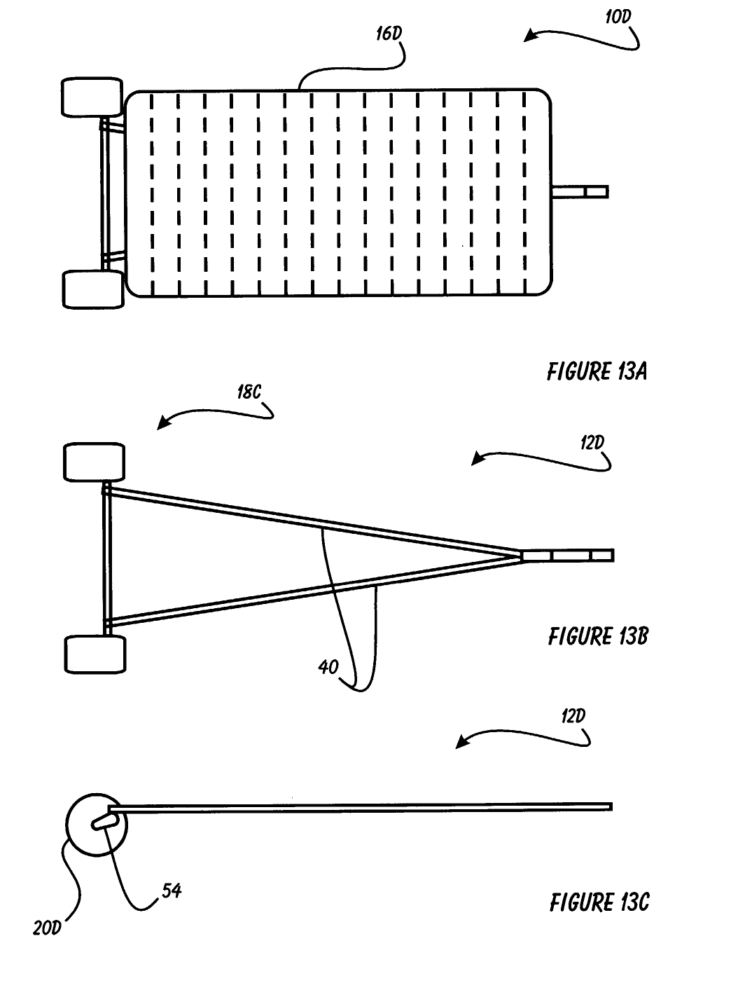

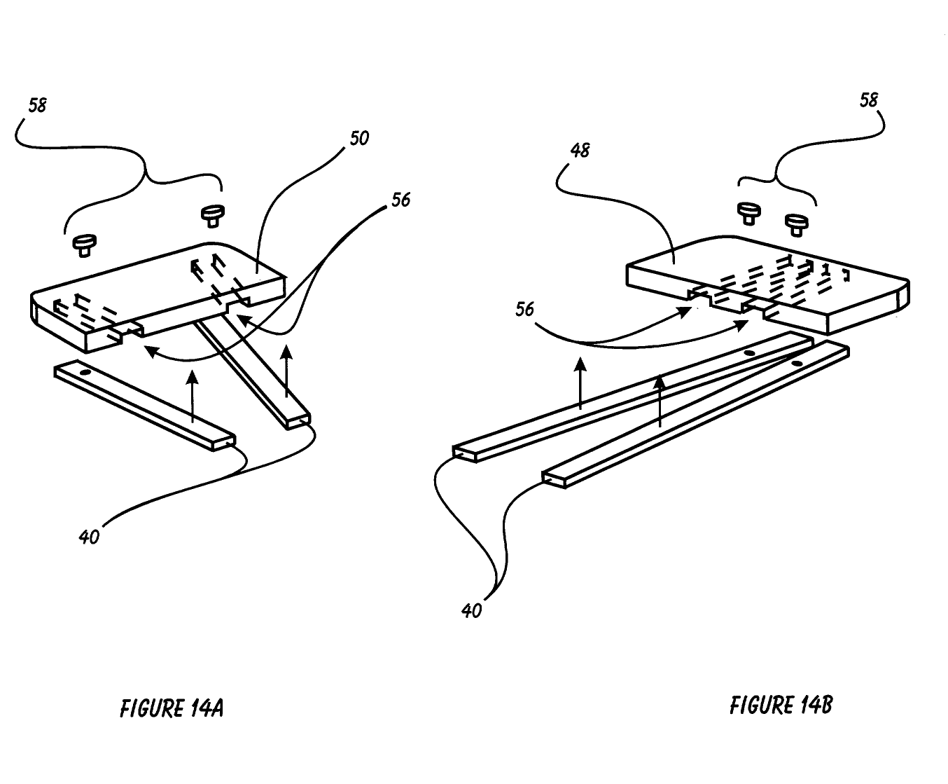

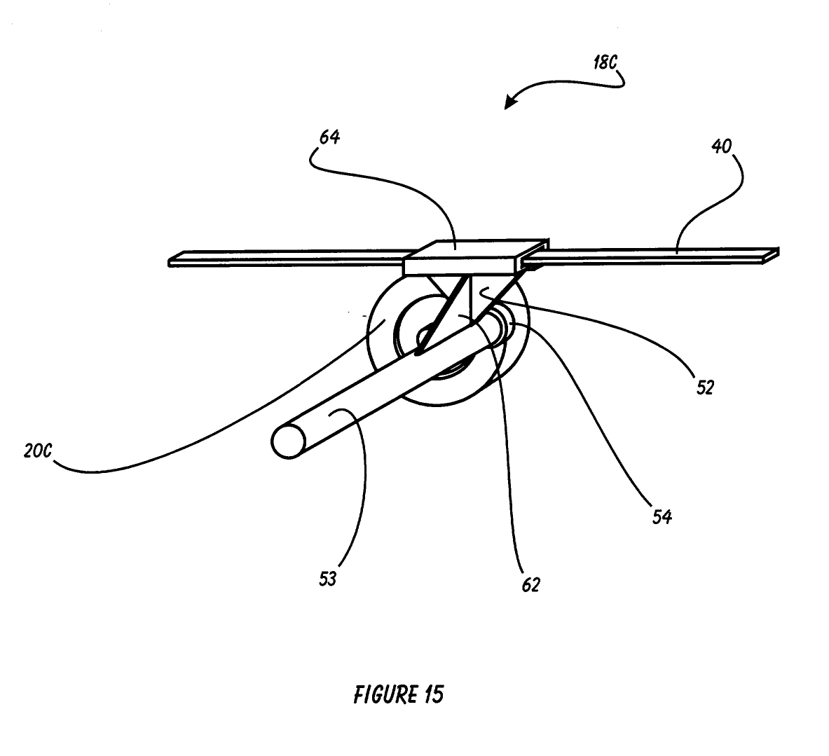

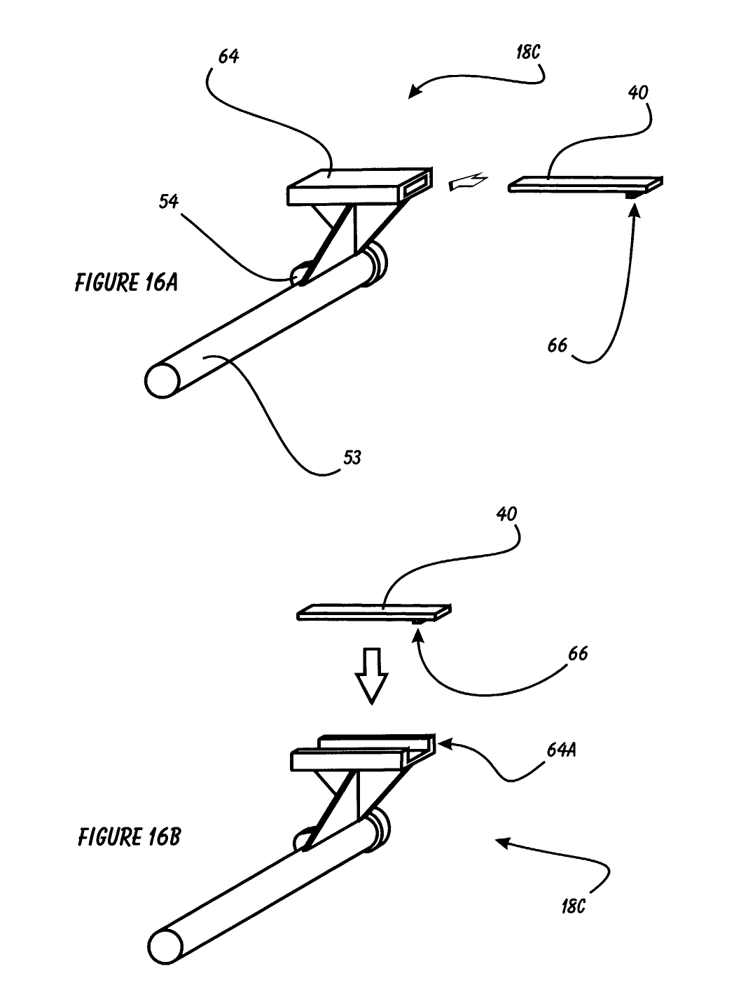

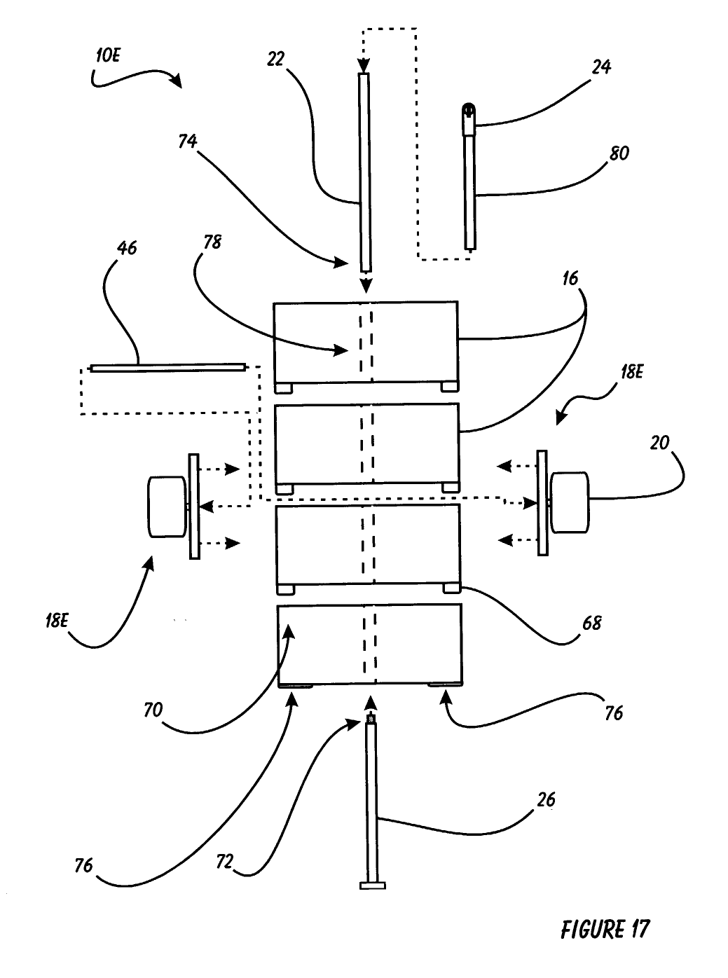

As shown in FIG. 12C, the wheel assemblies 20C are interconnected by a torsion axle 53, from which extends a pair of trailing arms 54. The torsion axle 53 provides biasing force to the trailing arms 54, which creates the suspension functionality of the assembly 18C. The torsion axle 53 is attached to the intermediate struts 40 by a pair of longitudinal fins 52. There will also be transverse fins interconnecting the torsion axle 53 to the struts 40, for example as depicted below in FIGS. 15 and 16. Now turning to FIGS. 13A-13B, we can see yet another alternate embodiment of the trailer 12D of the present invention. In this embodiment 12D, the suspension assembly 18D has been relocated at the distal ends of the intermediate struts 40 (relative to the hitch socket). In this manner, less clearance is necessary between the deck 16D and the ground, resulting in a lower profile for the trailer, as well as reducing the torsional forces created within the suspension assembly 18D (since the moment arm has been shortened). Now turning to FIGS. 14A and 14B, we can examine embodiments of the head and tail segments 48 and 50, respectively.

In FIG. 14A, we can see that the tail deck segment 50 may be formed with a pair of channels 56 formed in its bottom in order to accept the intermediate struts 40 therein. Once inserted within the channels 56, the struts 40 might be held thereto by one or more fasteners 58, such as bolts or even bolts having conventional or unique tie-down-type design to their heads (i.e. for providing a location to tie things to once the trailer is assembled). In FIG. 14B, we can see that the similar design might be employed in the formation of the head deck segment 48, wherein the intermediate struts 40 can be received within the channels 56 formed in the bottom of the head deck segment 48.

It should be appreciated that while these channels have only been shown in the head and tail deck segments, that they may be formed in the entire length of the deck of segments, to provide an extremely secure connection between the deck and the frame. Furthermore, it should be noticed that since (in the embodiments of the trailers shown in FIGS. 12 and 13) the intermediate struts 40 are in a triangular orientation, the channels 56 will also be at an angle; this angle will provide additional rigidity to the trailer because it will resist the longitudinal forces of being pulled. Still further, it is expected that while fully recessed channels 56 are shown here, in other embodiments, the channels 56 may be surface-mounted to the bottom of the segments in order to simplify construction (e.g. the channels could me made from angle stock).

Now turning to FIG. 15, we can examine how the trailer frame might be attached to the suspension assembly 18. In this example, we are using the suspension assembly of the third alternate embodiment of the suspension assembly 18C. As shown, the suspension assembly 18C comprises a pair of wheel assemblies 20C interconnected by a torsional suspension member or axle 53. The axle 53 is stabilized by a longitudinal fin 52 and a transverse fin 62 interconnecting the axle 53 with a sleeve 64. The sleeve 64 is dimensioned to accept the intermediate strut 40 therein. In this way, the amount of structural material is reduced (i.e. over other designs), and the resultant weight is reduced. Furthermore, it is a simple matter of inserting the struts 40 into the sleeves 64 when assembling the trailer. Other potential details are provided in FIGS. 16A and 16B.

In FIG. 16A, the strut 40 has a ridge protrusion 66 formed thereon for preventing the intermediate strut 40 from being pulled out in the frontward direction. By restraining the strut 40 from being released in this direction, the strut 40 is held securely to the suspension assembly 1 8C, despite the forces created on the struts 40 when the trailer is being pulled. Similarly, we can see in FIG. 16B, that with the open-topped alternate sleeve 64A, the strut 40 (in this example further including the ridge protrusion 66 formed thereon), can be more easily engaged and disengaged from the suspension assembly, while still providing substantial structural strength.

Looking now at FIG. 17, we can see yet another example of a collapsible trailer of the present invention. This trailer embodiment 10E comprises four or more deck segments 16A formed substantially from aluminum, plastic or other high-strength, lightweight material. Some of the deck segments 16 in this embodiment further include a system of interlocking protrusions and sockets, namely, a pair of pegs 68 extending from one side of the segment, and a cooperatively designed pair of sockets 70 on the facing side of the adjacent segment 16, such that when the deck is assembled, the pegs 68 fit into the sockets 70 to prevent twisting of the assembled deck (and to provide generally greater strength).

The segments 16 are further defined by a center bore 78 down their length; this bore 78 is provided to accept the frame members to be discussed further below (i.e. the frame members are actually inserted into the deck segments). The frame in this embodiment 10E comprises a first longitudinal strut 22, a second longitudinal strut 26 and a hitch strut 80. The hitch strut 80 terminates at its front end in the hitch socket 24, and is designed to interlock with the first longitudinal strut 22 at its rear end. The first longitudinal strut 22 is essentially a hollow tube having a substantially round cross-section, and terminating in an engaging socket 74. The engaging socket 74 is preferably a female threaded bore configured to accept an engaging peg 72 formed in the front end of the second longitudinal strut 26. The engaging peg 72 is preferably a male threaded peg for engaging the engaging socket 74. It should be understood that the peg 72 and socket 74 could be reversed (i.e. such that the socket 74 is formed in the second longitudinal strut 26).

To assemble the trailer 10E, therefore, one need simply assemble the segments such that the pegs 68 engage the sockets 70; insert the first and second longitudinal struts 22 and 26 into the (now-aligned) bores 78 and threadedly engage them tightly; attach the hitch strut 80 to the first longitudinal strut 22; and attach the suspension halves 18E and axle 46 to the assembled deck. The suspension halves 18E preferably attach to the sides of the center two segments 16; the axle 46 is attached between the two suspension halves 18E (typically prior to the attachment of the halves 18E to the deck). The order of assembly discussed herein is exemplary only; a number of factors may determine that other orders of assembly (and disassembly) of the trailer 10E are used.

Also shown in this FIG. 17 are two tail light assemblies 76 displayed on the rear surface of the rear segment 16; these tail light assemblies 76 are preferably of the type that are very sleek in order to reduce their interference with the stacking of the segments 16 (when the trailer is disassembled).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A collapsible trailer, comprising:
a frame comprising a suspension assembly, at least one longitudinal strut and a hitch mount; and
a deck comprising at least three deck segments, said deck detachably attachable to said frame.

2. The trailer of claim 1, wherein said deck segments are interconnected by at least one tensioning cable.

3. The trailer of claim 2, further comprising:
tensioning means for tensioning each said tensioning cable, said tensioning means attached to said deck.

4. The trailer of claim 3, wherein said suspension assembly further comprises:
a torsion axle defined by opposing ends;
a pair of trailing arms, one said trailing arm extending from each said opposing torsion axle end; and
a pair of wheel assemblies, one said wheel assembly attached to each said trailing arm.

5. The trailer of claim 3, wherein said intermediate struts are defined by a rear end and a head end, said frame formed in a generally triangular shape by attaching said head ends to said longitudinal strut in close proximity to one another, while said rear ends of said intermediate struts are spread apart further than said head ends.

6. The trailer of claim 3, wherein said deck further defines a head end and a tail end, said head end located substantially in the vicinity of said hitch socket and said tail end located substantially distal from said hitch socket, said deck further comprising:
a head deck segment located at said head end, said head deck segment further defined by one or more channels formed thereon to accept said intermediate struts therein; and
a tail deck segment located at said tail end, said tail deck segment further defined by one or more channels formed thereon to accept said intermediate struts therein.

7. The trailer of claim 3, further comprising a plurality of attaching means for detachably detaching said deck to said frame.

8. The trailer of claim 7, wherein said attaching means comprises fasteners inserted through apertures formed in said deck and threadedly engaged to threaded holes located in said frame.

9. The trailer of claim 7, wherein said attaching means comprises a plurality of buttons extending downwardly from said deck, said buttons being cooperatively located with a plurality of receivers formed in said frame, whereby said receivers can accept said buttons.

10. The trailer of claim 7, wherein said attaching means comprises a plurality of buttons extending upwardly from said frame, said buttons being cooperatively located with a plurality of receivers formed in the bottom side of said deck, whereby said receivers can accept said buttons.

11. The trailer of claim 3, wherein said suspension assembly further comprises at least two sleeves, said sleeves configured to accept said intermediate struts therein.

12. The trailer of claim 3, further comprising a pair of tail struts hingably attached to said suspension assembly.

13. The trailer of claim 1, wherein one said segment comprises:
a first edge, said first edge defined by at least one peg extending therefrom; and
a second edge opposing said first edge, said second edge defined by at least one socket formed therein, each said socket of the proper shape to accept one said peg therein.

14. The trailer of claim 13, wherein said segments comprise a center bore formed therein, said center bore configured to accept said at least one longitudinal strut.

15. The trailer of claim 14, comprising:
four said segments, a head segment, two center segments, and a tail segment, said head and said center segments each defined by at least one said peg extending therefrom, and said center segments and said tail segment defined by said sockets disbursed on said segments to cooperatively accept said pegs when said segments are aligned in close relation.

16. The trailer of claim 15, further comprising:
a second longitudinal strut insertible in said center bores, said second longitudinal strut defined by a first and second end and an engaging device at said first end; and
said first longitudinal strut defined by a first and second end and an engaging device at said second end, said engaging ends configured to interlock to form a frame from said first and second longitudinal struts.

17. The trailer of claim 16 wherein said tail segment comprises front edge and a rear edge, said rear edge further defined by a pair of recessed sockets; and
said trailer further comprises a pair of tail light assemblies insertible into said recessed sockets.

18. The trailer of claim 17, wherein:
said first longitudinal strut further comprises a hitch strut interlock formed at said first end; and
said trailer further comprises a hitch strut defined by a hitch socket end and a rear end, said rear end further defined by a longitudinal strut interlock for engaging said hitch strut interlock.
